(19) United States
(12) Patent Application Publication
(10) Pub. No.: US 2012/0095942 A1
(43) Pub. Date: Apr. 19, 2012

(54) METHOD OF DELEGATING SOLICITATION RESPONSIBILITIES OF COMMONLY-ACQUAINTED PROSPECTS WITHIN A MULTI-LEVEL MARKETING BUSINESS STRUCTURE

(76) Inventor: Mitch Huhem, San Diego, CA (US)

(21) Appl. No.: 12/905,941

(22) Filed: Oct. 15, 2010

(51) Int. Cl. G06Q 90/00

(52) U.S. Cl. 705/500

(57) ABSTRACT

A method is disclosed for soliciting commonly acquainted prospects into a hierarchal multi-level marketing (MLM) structure by collecting contact information of personal contacts from MLM members already incorporated, and soliciting those personal contacts using a third-party solicitor to build a commission downline for current members who are reluctant, unwilling or inefficient at soliciting their own personal contacts.

### BACKGROUND OF THE INVENTION

1. Field of the Invention

This invention relates to multi-level marketing, and more particularly relates to a method of recruiting members in a hierarchical multi-level marketing business structure.

2. Description of the Related Art

Many consumer products, services, and opportunities are sold and marketed within multi-level marketing (MLM) hierarchical business structures (hereinafter the “MLM structures”), which remunerate members of the MLM structures in accordance with the amount of subsequent, or downline, members they recruit and sales they realize.

MLM structures assume responsibility for the sale of the consumer products, services, and/or opportunities, as well as for managing commissions to certain members of the MLM structures who successfully bring other member(s) into the MLM structure. Companies adopting, or assuming, an MLM structure allow their members to profit not just from sales those members effectuate, but also from sales effectuated by newer members brought into the MLM structure by older members.

MLM structures organize their members into hierarchical pay grades, or levels, and distribute commissions made on the sale of consumer products by trickling the commissions up to members in higher levels, particularly those members who were responsible for the incorporation of the members responsible for making sales.

Often MLM structures will provide their members with printed instructions and/or training in methods of both selling consumer products and recruiting others into the MLM structure. Typical methods of recruiting others include conferences in which potential members, and contacts of members, are given the opportunity to socialize with experienced members, experience multimedia presentations of various species, hear testimonials of successful members, and become acquainted with the particular implementation of the MLM structure assumed by the company or organization distributing the one or more consumer product(s) underlying the MLM structure.

Many companies implementing MLM structures have enjoyed remarkable success in years past, but other MLM companies have struggled due to the inability and/or reluctance of many members, and potential members, to participate in the MLM marketing programs. Many members and potential members are hesitant to recruit their personal and professional contacts into the MLM structure. Members may lack the ability to successfully recruit their contacts, or may be disinclined to strain relationships they have established with their contacts by subjecting those contacts to the rhetoric necessary to successfully recruit them. These members may be similarly disinclined to solicit sales of the consumer product(s) marketed by the MLM structure from their personal and professional contacts.

Many members of MLM structures come to exist in name only, without realizing new member recruits or producing consumer product sales. These members may discontinue or dishonor obligations incidental to their membership in the MLM structure, such as membership fees or obligations to purchase MLM products. These problems inherent in traditional MLM structures have caused MLM structures to suffer low member retention rates, inefficient new member recruitment drives, and unproductive solicitation of new sales from member contacts.

### SUMMARY OF THE INVENTION

From the foregoing discussion, it should be apparent that a need exists for a method for soliciting commonly acquainted prospects into a multi-level marketing business structure. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a method for soliciting selected commonly acquainted prospects into a multi-level marketing business structure.

A first method is disclosed for selling a consumer product to commonly acquainted personal contacts of an MLM member, the steps of the method performed by the solicitor. The steps of the method comprise: assuming responsibility for building an MLM member's downline for the MLM member; receiving the contact information for one or more personal contacts from the member; soliciting each of the personal contacts; selling a consumer product to the one or more of the personal contacts; arranging for the MLM structure to auto-ship a consumer product to one or more of the personal contacts at reoccurring intervals; and incorporating one or more of the personal contact(s) into the MLM structure in a downline of the member.

A second method is disclosed for shifting responsibility for selling a consumer product offered by a multi-level marketing (MLM) structure from a member of the MLM structure to a solicitor, wherein the solicitor solicits individuals commonly acquainted with the member of the MLM structure, the steps of the method performed by the solicitor, the steps of the method comprise prompting the member to provide a list of one or more of the names, telephone numbers, email addresses, ethnic background, income, religious affiliation, health, age, gender, native language, and mailing addresses (collectively the “contact information”) of one or more of family members, friends, coworkers, acquaintances, and neighbors (collectively the “personal contacts”); and receiving the contact information in written form to the member.

The steps of the method also comprise initiating telephonic contact with one or more of the personal contact(s) via the solicitor and informing each of the one or more the personal contact(s) of the existence of a common personal relationship between the solicitor and the member, and the personal contact(s) and the member.

The solicitor, in some embodiments, complements one or more of the personal contact(s); offers one or more of the personal contact a free product sample. The solicitor sells a consumer product to the one or more of the personal contact(s); and arranges for the MLM structure to auto-ship a consumer product to one or more of the personal contacts at reoccurring intervals, such as monthly.

The steps of the method further comprise incorporating one or more of the personal contact(s) into the MLM structure in a downline of the member.

A third method is disclosed for efficiently recruiting prospective multi-level marketing (MLM) members to an MLM structure, wherein the prospective MLM members are personally acquainted with a current MLM member, the method performed by members of an MLM structure. The steps of the method comprise incorporating a member into a hierarchal MLM structure, wherein the member is remunerated by the MLM structure in the form of commissions on sales realized to additional members joining the MLM structure after the member is incorporated; and prompting the member to provide a list of one or more of the names, telephone numbers, email addresses, ethnic background, income, religious affiliation, health, age, gender, native language, and mailing addresses (collectively the “contact information”) of one or more of family members, friends, coworkers, acquaintances, and neighbors (collectively the “personal contacts”).

The steps of the method further comprise contacting each of the personal contacts with a message seemingly from the member, the message comprising one or more of: a recorded telephone call, a telephone call commenced by the member, a product sample, an email, a letter, an SMS text message, and an MMS message; forwarding the contact information in written form to a solicitor; and initiating telephonic contact with each of the personal contacts via the solicitor.

The steps of the method further comprise informing each of the personal contacts that the member has directed the solicitor to initiate contact; soliciting the personal contacts to join the MLM structure; incorporating one or more of the personal contact(s) into the hierarchal MLM structure in a downline of the member, wherein the personal contact(s) are remunerated by the MLM structure in the form of commissions on sales realized to additional members joining the MLM structure after the personal contact(s) are incorporated; and building the downline of the member by repeating the steps of the method for each personal contact.

In some embodiments of the present invention, the method further comprises gauging the member's reluctance to solicit personal acquaintances using a written questionnaire. In other embodiments, the personal contact(s) incorporated into the MLM structure are incorporated into a dual downline structure, wherein the member receives a commission from sales realized to the incorporated personal contact(s) and each of their respective down lines, and wherein the solicitor receives a commission from sales realized to the incorporated personal contact(s) and each of their respective down lines.

In still further embodiments, the contact information is forwarded to one of a plurality of solicitors who shares a maximum number of commonalities with the personal contacts, the commonalities determined by referencing the contact information.

In alternative embodiments, the method further comprises: forcing the member to fill out a prospect referral form with the contact information; and instructing the member to return the prospect referral form within a predetermined amount of time.

The method may further comprise coaching the member through filling out the prospective referral form. In some embodiments, the prospective referral form comprises fields for written descriptions by the member of: how the member met one or more personal contact(s), what the personal contact(s) look like, what hobbies the personal contact(s) maintain.

In some embodiments, the method further comprises guarantying the member a predetermined amount of income during the duration that the member continuously provides contact information for new personal contacts. In other embodiments, the method alternatively or additionally comprises scheduling an appointment with one more of the personal contacts; and notifying the member that the appointment has been scheduled.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an entity-relationship diagram illustrating the relationship between entities in an MLM structure working together to solicit selected commonly acquainted prospects into a multi-level marketing structure in accordance with the present invention;

FIG. 2 is an entity-relationship diagram illustrating the relationship between entities in an MLM structure working together to solicit selected commonly acquainted prospects into a multi-level marketing structure in accordance with the present invention;

FIG. 3 is a process flow chart of a method of soliciting selected commonly acquainted prospects into a multi-level marketing structure in accordance with the present invention;

FIG. 4 is an entity-relationship diagram illustrating the relationship between entities operating in conjunction with an MLM structure to solicit selected commonly acquainted prospects into a multi-level marketing structure in accordance with the present invention; and

FIG. 5 is a process flow chart of a method of soliciting selected commonly acquainted prospects into a multi-level marketing structure in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

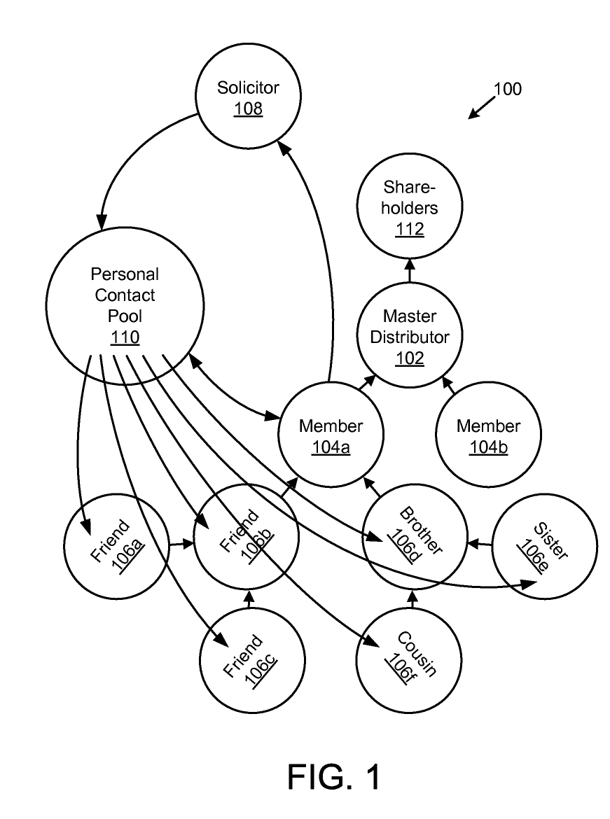

FIG. 1 is an entity-relationship diagram illustrating the relationship 100 between entities in an MLM structure working together to solicit selected commonly acquainted prospects into a multi-level marketing structure in accordance with the present invention. The entity-relationship 100 comprises a master distributor 102, a member 104a, a member 104b, a friend 106a, a friend 106b, a friend 106c, a brother 106d, a sister 106e, a cousin 106f, a solicitor 108, a personal contact pool 110, and shareholders 112.

Each of the entities in the relationship 100 form part of an MLM structure, which markets a consumer product, service or business opportunity. The consumer product may comprise any valuable item which can be purchased, tangible or intangible. Examples of consumer products may include fruit drinks, vitamins, cleaners, cars, computers, tools, and the like. The consumer product may be intangible, and/or comprise video, audio, digit text files, or the like.

For the purposes of this patent, the term “MLM structure” denotes a multi-level marketing business structure that incorporates its members in hierarchical pay grades, or levels, and remunerates commissions to members in higher levels for the sales of consumer products realized by members in lower levels whom have been incorporated into the MLM structure as a result of the efforts of members in the higher levels. MLM structures are well-known to those of skill in the art.

The members 104a-b may comprise any person, company or organization that is potentially a customer of another person, company or organization. The members 104a-b may purchase one or more consumer products and become “incorporated” into the MLM structure, or the members 104a-b may purchase the consumer product and not become incorporated. For the purposes of this patent, the terms “incorporate” and “incorporation” denote the act of formally enrolling an individual or organization into an MLM structure such that the individual or organization receives commissions on downline sales (sales realized as a result of the efforts of contacts of the individual or organization which are later incorporated), through a mutually recognized business relationship with the MLM structure.

Like the members 104a-b, the prospective member 106a-f may comprise any person, company or organization that is potentially a customer of another person, company or organization. The prospective members 106a-f may purchase one or more consumer products and become “incorporated” into the MLM structure, or the prospective members 106a-f may purchase the consumer product and not become incorporated.

In the shown embodiments, once a member 104a has been incorporated into the MLM structure, the member is prompted to provide contact information of personal and professional acquaintances with whom the member 104 maintain personal and/or professional relationships. The member 104a may be forced, prompted, or instructed to fill out a referral form comprising fields for written notation of contact information.

The contact information, in this embodiment, comprises information about the prospective members 106a-f with whom the member 104a associates personally or professionally. The contact information may comprise information about individuals and organizations not associated with the member 104a. The contact information may include one or more of: age, address, gender, credit rating, email, telephone number, income, education, purchasing practices, and the like. In typical embodiments, the contact information is written down by the member 104 and transferred to the solicitor 108 on a printed medium or using programs well-known to those of skill in the art, such Microsoft Outlook, Thunderbird, Yahoo! Mail, and the like.

The personal contact pool 110 comprises all the personal and professional contacts of the member 104a, including friends 106a-c, brother 106d, sister 106e, and cousin 106f. The personal contact pool 110 may also comprise co-workers, friends, neighbors and the like as described above. Because each of the personal contracts are commonly acquainted for the purposes of the present invention.

The member 104a puts the solicitor 108 in contact with the personal contacts in the personal contact pool 110, and the personal contacts of the member 104a are solicited by the solicitor 108 telephonically or in person to purchase a product, service or opportunity offered by the MLM business structure.

The solicitor 108, in some embodiments, may comprise a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In those embodiments in which the solicitor 108 comprises a human being, the solicitor 108 may profit residually from incorporating the personal contacts into the MLM structure. In some embodiments of the present invention, the MLM structure comprises a plurality of downline compensation schemes, in which a single member 104 may form part of more than one downline. For instance, the member 104a may profit from all subscription, auto-shipping, fees, sales, purchases and exchanges made by a personal contact incorporated into the MLM structure, and the solicitor 108 who solicited the personal contact to join the MLM structure may also profit from that personal contact, and have a separate downline comprising all of the personal contact of a plurality of members 104 whom the solicitor 108 has successfully incorporated into the MLM structure.

The MLM structure may comprise a direct sales company (DSC), such as Mary Kay. Autoshipping, or auto-ship, for the purposes of the present invention described shipping a product a regular intervals to a customer and automatically charging the customer for that product.

In some embodiments, the MLM structure may automatically make commission payments to members incorporated into the MLM structure via means well-known to those of skill in the art, including PayPal , credit card credits, direct bank deposits, and the like. Commission payments to members may be made in accordance with a predetermined MLM criteria. In some embodiments, the predetermined MLM criteria is dynamic, and optimized automatically through analysis of historical MLM sales data to maximize profits to the MLM structure and/or MLM members.

In the shown embodiment, the solicitor interacts electronically with the member 104a using variations of the Simple Mail Transfer Protocol (SMTP), Internet Message Access Protocol (IMAP), Post Office Protocol (POP), or other protocols well-known to those of skill in the art.

The relationship 100 includes a solicitor 108. The solicitor 108 may comprise a DPD, a company or organization which solicits customers 110, an individual, or any combination of the above. In the shown embodiment, the solicitor 108 comprises a DPD controlled by an MLM structure interested in soliciting potential MLM members and/or customers 110. In some embodiments, the solicitor 108 is configured to interact with a customer 110 through a graphical user interface (GUI) coupled to a DPD or the maintenance server 102. The solicitor 108 is configured to retrieve and/or receive the contact information 116 from, or through, the maintenance server 102. In some embodiments, the solicitor 108 may be configured to receive the contact information 116 as an email attachment using variations of the Simple Mail Transfer Protocol (SMTP) FTP, Internet Message Access Protocol (IMAP), Post Office Protocol (POP), or other protocols well-known to those of skill in the art.

The shareholders 112 are the owners of the MLM structure who ultimately, in the shown embodiment, profit from the MLM structure in the form of dividends, distributions, salaries, and the like.

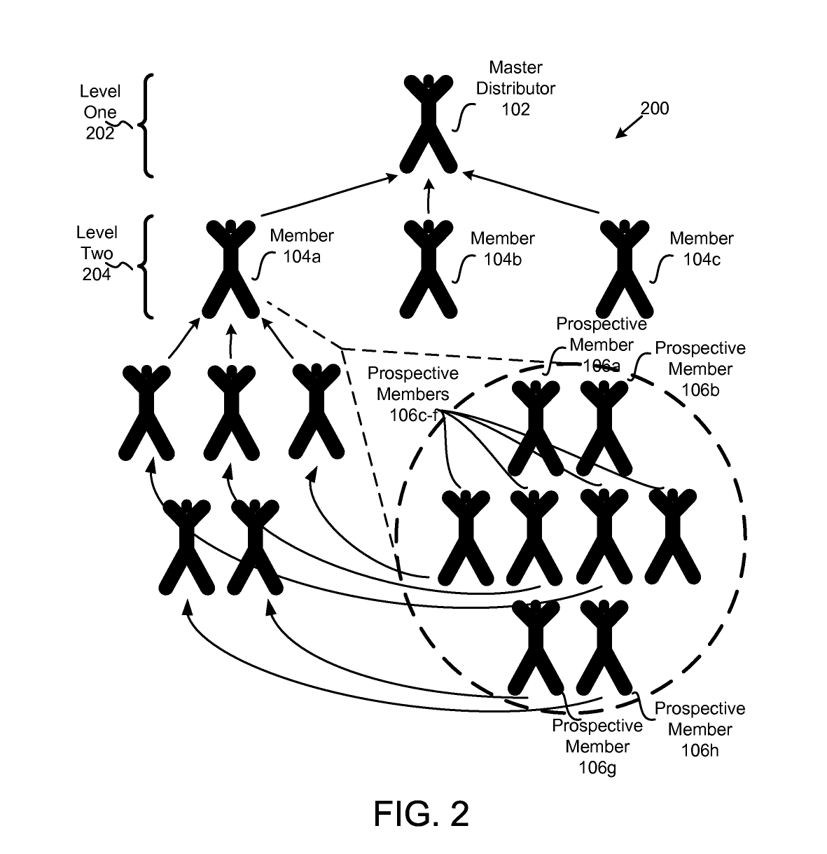

Referring now to FIG. 2, an entity-relationship diagram of entities involved in soliciting selected commonly acquainted prospects into a multi-level marketing structure in accordance with the present invention. The entity-relationship 100 comprises a master distributor 102, a member 104a, a member 104b, a member 104c, a friend 106a, prospective members 106a-f shown in a personal contact pool, a level one 202, and a level two 204.

The master distributor 102, members 104a-c, and MLM structure a substantially described above in relation to FIG. 1.

The prospective members 106a-f, in the shown embodiment, comprise the personal contacts of the member 104a. In various embodiments of the present invention, the solicitor 108 interacts electronically with DPDs under the control of the member 104a via the Internet, and copies personal contact information stored in database files under the exclusive control of the member 104a.

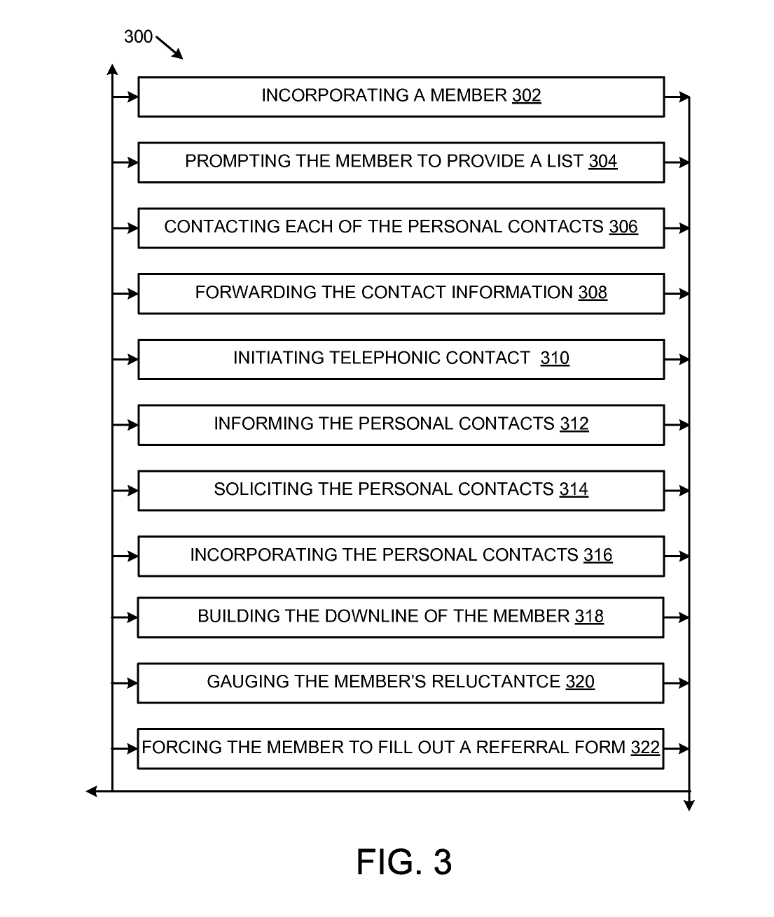

Referring now to FIG. 3, a process flow chart of a method of soliciting selected commonly acquainted prospects into a multi-level marketing structure in accordance with the present invention.

In some embodiments of the present invention, the member 104 first contacts his personal contacts before relaying their contact information to the solicitor 108. In various embodiments of the present invention, the member 104 may send a sample product and personalized message to one or more of his personal contacts before those contacts are solicited by the solicitor 108.

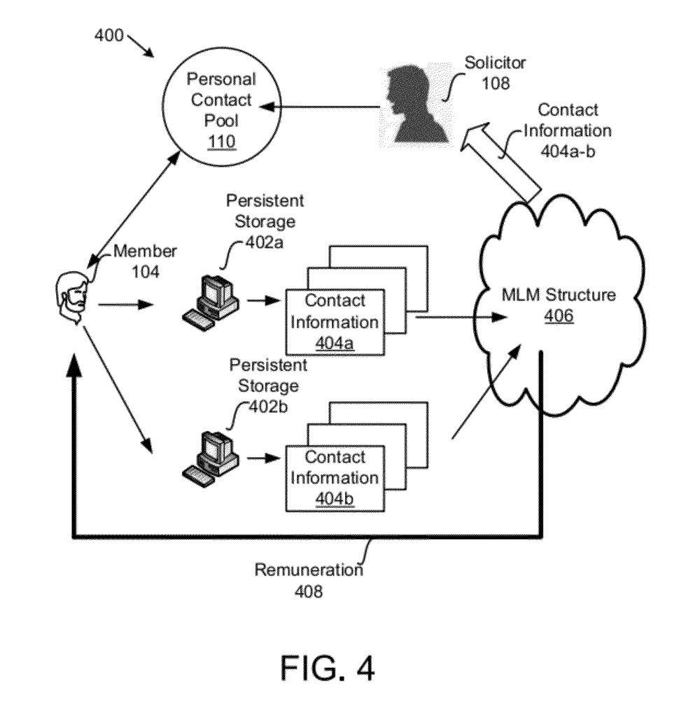

FIG. 4 is an entity-relationship diagram illustrating the relationship 400 between entities operating in conjunction with an MLM structure to solicit selected commonly acquainted prospects into a multi-level marketing structure in accordance with the present invention. The relationship 400 comprises a member 104, a solicitor 108, a personal contact pool 110, persistent storage 402a-b, contact information 404a-b, a MLM structure, 406, and remuneration 408.

The member 104, solicitor 108, personal contact pool 110, contact information 404a-b, and MLM structure 406 are all substantially described above in relation to FIGS. 1-3.

The persistent storage 402a-b may comprise a computer, DPD, harddrive, cell phone SD card, flash memory drive, or any other computer-readable or human-readable record of personal contacts and their contact information 404.

The remuneration 408 comprises payment made by the MLM structure 406 to the member 104 in the form of commission realized on product sales by the solicitor 108 to the personal contacts, or downlines of the member 104.

In this embodiment, the member 104 accesses contact information 404a-b stored in persistent storage 402a-b and forwards that contact information 404a-b to the MLM structure 406. The contact information 404a-b is then relayed to the solicitor 108 who contacts the personal contacts comprising the personal contact pool 110 and attempts to sell them product and/or incorporate them into the MLM structure 406.

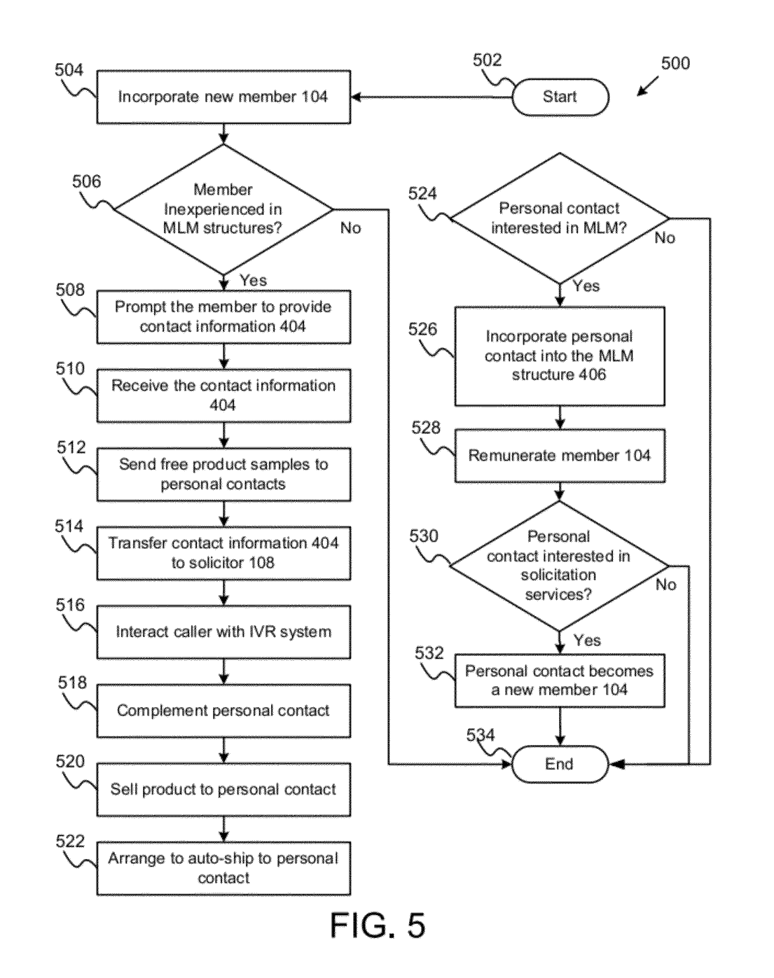

FIG. 5 is a process flow chart of a method 500 of soliciting selected commonly acquainted prospects into a multi-level marketing structure in accordance with the present invention.

The method 500 begins 502 when a new member 104 is incorporated 504 into the MLM structure 406. The member is prompted 506 to take a quiz on how experienced and/or reluctant the member 104 is to solicit personal contacts to join the MLM structure. If the member 104 is determined to be reluctant (or inexperienced) in soliciting personal contacts, the method 500 proceeds and prompts 508 the member 104 for personal contact information 404.

The remaining steps proceed as shown, with the solicitor 108 gauging 524 a personal contact's interest in having the solicitor repeat the method 500 from the beginning for the personal contact, with the personal contact now acting as the member 104.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of selling a consumer product to commonly acquainted personal contacts of an MLM member, the steps of the method performed by the solicitor, the steps of the method comprising:
assuming responsibility for building an MLM member's downline from the member;
receiving contact information for one or more personal contacts of the member;
soliciting each of the personal contacts;
selling a consumer product to one or more of the personal contacts;
arranging for an MLM structure to auto-ship a consumer product to one or more of the personal contacts at reoccurring intervals; and
incorporating one or more of the personal contact(s) into the MLM structure in a downline of the member.

2. A method of shifting responsibility for selling a consumer product offered by a multi-level marketing (MLM) structure from a member of the MLM structure to a solicitor, wherein the solicitor solicits individuals commonly acquainted with the member of the MLM structure, the steps of the method performed by the solicitor, the steps of the method comprising:
prompting the member to provide a list of one or more of the names, telephone numbers, email addresses, ethnic background, income, religious affiliation, health, age, gender, native language, and mailing addresses (collectively the “contact information”) of one or more of family members, friends, coworkers, acquaintances, and neighbors (collectively the “personal contacts”);
receiving the contact information in written form to the member;
initiating telephonic contact with each of the personal contacts via the solicitor;
selling a consumer product to the one or more of the personal contacts;
arranging for the MLM structure to auto-ship a consumer product to one or more of the personal contacts at reoccurring intervals; and
incorporating one or more of the personal contact(s) into the MLM structure in a downline of the member.

3. The method of claim 2, further comprising initiating telephonic contact with one or more of the personal contact(s) via the solicitor and:
informing each of the one or more the personal contact(s) of the existence of a common personal relationship between the solicitor and the member, and the personal contact(s) and the member;
complementing one or more of the personal contact(s); offering one or more of the personal contact a free product sample;

4. A method of efficiently recruiting prospective multi-level marketing (MLM) members to an MLM structure, wherein the prospective MLM members are personally acquainted with a current MLM member, the method performed by members of an MLM structure, the steps of the method comprising:
incorporating a member into a hierarchal MLM structure, wherein the member is remunerated by the MLM structure in the form of commissions on product sales realized to additional members joining the MLM structure after the member is incorporated;
prompting the member to provide a list of one or more of the names, telephone numbers, email addresses, ethnic background, income, religious affiliation, health, age, gender, native language, and mailing addresses (collectively the “contact information”) of one or more of family members, friends, coworkers, acquaintances, and neighbors (collectively the “personal contacts”);
forwarding the contact information in written form to a solicitor;
initiating telephonic contact with each of the personal contacts via the solicitor;
informing each of the personal contacts that the member has directed the solicitor to initiate contact;
soliciting the personal contacts to join the MLM structure;
incorporating one or more of the personal contact(s) into the hierarchal MLM structure in a downline of the member, wherein the personal contact(s) are remunerated by the MLM structure in the form of commissions on product sales realized to additional members joining the MLM structure after the personal contact(s) are incorporated; and
building the downline of the member by repeating the steps of the method for each personal contact.

5. The method of claim 1, further comprising contacting each of the personal contacts with a message seemingly from the member, the message comprising one or more of: a recorded telephone call, a telephone call commenced by the member, a product sample, an email, a letter, an SMS text message, and an MMS message.

6. The method of claim 1, further comprising gauging the member's reluctance to solicit personal acquaintances using a written questionnaire.

7. The method of claim 1, wherein the personal contact(s) incorporated into the MLM structure are incorporated into a dual downline structure, wherein the member receives a commission from product sales realized to the incorporated personal contact(s) and each of their respective down lines, and wherein the solicitor receives a commission from product sales realized to the incorporated personal contact(s) and each of their respective down lines.

8. The method of claim 1, wherein the contact information is forwarded to one of a plurality of solicitors who shares a maximum number of commonalities with the personal contacts, the commonalities determined by referencing the contact information.

9. The method of claim 1, further comprising:
forcing the member to fill out a prospect referral form with the contact information; and
instructing the member to return the prospect referral form within a predetermined amount of time.

10. The method of claim 9, further comprising coaching the member through filling out the prospective referral form.

11. The method of claim 9, wherein the prospective referral form comprises fields for written descriptions by the member of: how the member met one or more personal contact(s), what the personal contact(s) look like, what hobbies the personal contact(s) maintain.

12. The method of claim 1, wherein the solicitor collects the contact information from the member telephonically, and the solicitor transcribes the contact information on paper.

13. The method of claim 1, further comprising guarantying the member a predetermined amount of income during the duration that the member continuously provides contact information for new personal contacts.

14. The method of claim 1, further comprising guarantying the member a predetermined amount of contacts with the personal contacts during the duration that the member remains incorporated into the MLM structure.

15. The method of claim 1, further comprising:
scheduling an appointment with one more of the personal contacts; and
notifying the member that the appointment has been scheduled.
